(19) United States
(12) Patent Application Publication
(10) Pub. No.: US 2013/0054350 A1
(43) Pub. Date: Feb. 28, 2013

(54) System and Methods for Measuring Exposure to Media

(71) Applicant: Camiel Camps, Utrecht (NL)

(72) Inventor: Camiel Camps, Utrecht (NL)

(21) Appl. No.: 13/219,594

(22) Filed: Aug. 26, 2011

(51) Int. Cl. G06Q 30/02

(52) U.S. Cl. 705/14.44

(57) ABSTRACT

A method for measuring the reach of media content distributed within time slots of a radio or television broadcast or other media outlet. Statistics representative of audience exposure to such media content are derived from recollections gathered from a first quantity of respondents who, collectively, constitute a representative sample across all socio-demographic segments of a relevant population. From these recollections, which identify media content to which respondents were exposed during recollection intervals, first audience statistics are derived for respective time intervals of interest. Second audience statistics, representative of audience exposure to media content during time slots falling within the time intervals of interest, is derived from a plurality of audiometric measurements collected from a second quantity of representative respondents substantially smaller than the first. The sets of audience statistics are combined to yield an enhanced “hybrid” assessment of reach, market share, and gross rating points for any media content distribution event(s) and any selected socio-demographic groups.

### BACKGROUND OF THE INVENTION

1. Field of the Invention

This disclosure relates generally to market research, and, more particularly, to methods and apparatus for measuring a subject's exposure to media.

2. Discussion of the Background Art

Advertisers of goods and services are always looking for ways to verify that their marketing messages are reaching the intended audience and to develop advertising plans which make the most efficacious use of the available media channels (e.g. broadcast radio, television, newspapers and magazines, and the like). Similarly, the radio or television station operator is often asked to justify the price charged for advertising time slots—a task made easier when the demographic characteristics of the audience, during different time intervals throughout the day, can be measured in a reliable and repeatable fashion. Radio and television operators also have an interest in tracking how appealing their respective programming is to various segments of their prospective audiences, as do the producers of such media content as movies, songs, and video games distributed via other media outlets such, for example, as the internet, compact discs, DVDs and the like.

Even as media usage and exposure continues to increase (8- to 18-year olds average over 6 hours of media exposure per day), however, there is no established standard for assessing media exposure that has an acceptable level of reliability or validity, and the costs associated with such measurements vary substantially with the technique used. One commonly used memory-based technique relies upon time use diaries (TUDs) wherein respondents make entries, for example in quarter-hour increments, in a diary to capture their recollections of what broadcast station they were listening to or viewing, and optionally, whether they remember any specific advertisement from the broadcast. Another memory-based technique involves the collection of recall estimates (REs), usually by conducting telephonic interviews of randomly selected respondents intended to represent a larger population. The respondents are asked to recall and relate the media to which they were exposed during specific intervals of time (e.g., consecutive fifteen minute periods between the hours of 07:00 to 09:00 of the previous day or preceding two to seven days). These memory-based techniques, although they may require a respondent count exceeding a thousand or more for a given market, tend to be the most commonly used because they are very easy and inexpensive to set up and administer. Their principal disadvantage lies in the fact that the memories of the respondents are often incomplete and at best represent only a coarse estimate of their exposure to media. As such, memory-based exposure measurement techniques are not able to deliver the kind of minute-by-minute granularity that would be of greatest interest to advertisers and other parties.

Recognizing the aforementioned deficiencies associated with memory-based audient measurement techniques, a number of market research companies have developed a and introduced portable meter devices which they furnish to groups of respondents. These devices are typically configured so that they can be worn or carried at all waking times. Each meter device samples the audible acoustic energy to which a corresponding respondent is exposed. The audio sampling is entirely passive in that it takes place without the need for any input or involvement by the respondents, and thus provides a complete and very granular measurement of the audio portion of the particular media content to which a respondent has been exposed. Through either “fingerprinting”, in which a collected audio sample is compared to a library of audio samples, or “watermarking”, in which the sampled signal contains an identifying portion allowing identification, information about the media content to which a respondent has been exposed (e.g. the identity of a radio or television broadcaster, the name of a song or artist, or the name of a video game)—as well as the duration of that exposure—can be monitored over any desirable interval. Despite the accuracy and granularity which can be obtained through passive audio sampling techniques, a major obstacle to their broader implementation has been the high cost of implementation. In addition to the cost of the devices themselves, arrangements must be made to collect, process, and analyze the samples they collect.

A continuing need therefore exists for a measuring technique which can provide sufficient granularity as to be useful to parties interested in measuring exposure, of a relevant population, to media content during selected time intervals, without necessitating the high expenditures associated with conventional passive measurement methodologies.

A further need exists for an effective method for measuring the reach and gross rating points of a particular broadcast or marketing message.

### SUMMARY OF THE INVENTION

The aforementioned needs are addressed, and an advance is made in the art, by a method for measuring the reach of media content having an audio component, the media content being delivered via a media outlet. The method includes deriving, from the recorded recollections of a plurality of respondents, memory-based statistics representative of audience exposure to an audio component of media content. The recorded recollections may be extracted from diary entries which are made by respective respondents who collectively constitute a representative sample across all socio-demographic segments of a relevant population. Each respondent diary may contain a series of entries corresponding to media exposure activity. for that particular respondent. within a defined diary interval. Alternatively, the recorded recollections may be obtained as recall estimates gathered by telephonically contacting such respondents and asking about their media consumption over defined intervals during one or more preceding days (or portions thereof). From the recorded recollections, a first set of reach values can be constructed by station and demographic group, within a prescribed time interval.

The method further includes deriving audiometrically-based statistics representative of audience exposure to media content from a plurality of audiometric measurements collected passively from representative respondents. A plurality of time slots during which media content exposure activity of interest may have occurred via at least one media channel are identified, and audience exposure measurement statistics are combined so as to yield an enhanced “hybrid” assessment of reach for any given media content and any selected socio-demographic groups.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a flow chart representing exemplary machine readable instructions that may be executed to implement systems and methods for obtaining enhanced measurements of reach, market share and rating for media channels and media content delivered by such channels according to illustrative embodiments of the invention;

FIG. 2 is a flow chart representing exemplary machine readable instructions that may be executed, in accordance with the exemplary embodiment of the invention depicted in FIG. 1, to derive media exposure statistics from recollections, of exposure to media content during at least one time interval, captured as entries in respondent time-use diaries;

FIG. 3 is a flow chart representing exemplary machine readable instructions that may be executed, in accordance with the exemplary embodiment of the invention depicted in FIG. 1, to derive media exposure statistics from stored audiometric measurements representative of respondent exposure to media channels and content during respective time slots encompassed by one or more time-use diary intervals;

FIG. 4 is a flow chart representing exemplary machine readable instructions that may be executed to obtain hybrid measurements of media content and/or channel reach by combining derived media exposure statistics obtained by at least two different methodologies in accordance with the present invention;

FIG. 5 is a tabular representation of reach, average reach, and index values for a representative station/time interval combination;

FIG. 6 is a graphical representation depicting variations in derived reach statistics with respect to time; and

FIG. 7 is a block diagram of an example processor system that may be used to execute the exemplary machine readable instructions depicted in FIGS. 1-4.

Like reference numerals indicate like elements in the drawings. Unless otherwise indicated, elements are not drawn to scale.

### DETAILED DESCRIPTION

Exposure to media content such, for example, as advertising messages and programming delivered by media outlets such as broadcast television and radio stations, cable and satellite networks, and the internet is typically studied by obtaining information on a limited number of respondents. Initially, it should be noted that as utilized herein, the term “broadcast” in the context of television and radio stations is intended to encompass all forms of media content distribution including transmission over cable, satellite, over-the-air and the internet.

The method by which respondent information is collected often varies in accordance with the budget of the client(s) requesting the exposure measurements. For example, memory-based recollections—gathered from a representative plurality of respondents either by contacting them by phone and asking for them to “recall” their exposure activity from one or more prior days (e.g., “yesterday recall estimates”) or by gathering time use diaries in which the exposure activity of the respondents within discrete intervals is recorded over a period of days or weeks—are relatively inexpensive to set up and administer. If the number of respondents is sufficiently large and socio-demographically diverse as to reflect the overall population to be measured, the memory-based recollections gathered can be successfully used to project audience reach, market share, and rating points for advertisements and other media content distributed, for example, by a radio or television station. The respondents may be recruited as panelists for monitoring over a relatively long period, or on a one-time basis for a media reach study commissioned for a client or group of clients in one or more targeted markets.

The aforementioned memory-based recollection data, and methods for gathering the same, are particularly useful where the level of reporting granularity can be met by recollection intervals of fifteen minutes or more. However, respondents cannot be counted upon to reliably recall or report their media exposure activity with sufficient granularity (e.g., on a minute-by-minute basis) as to allow measurements of exposure to thirty or sixty second advertising messages or other specific portions of media content falling within the discrete time slots making up a recollection interval.

For time slots smaller than fifteen minutes or so, it has heretofore been necessary to equip respondents with audiometric devices configured to passively monitor the audio component of the media content. In that regard, it will be noted that to obtain measurements which are representative of an entire audience or target market, the number of respondents needs to be about the same (e.g., on the order of three or more thousand) as is associated with memory-based recollection techniques. The attendant costs, which include not only the devices themselves, but also the equipment for transmitting, receiving and processing the audiometric measurements, are often considered prohibitive by the parties involved.

The inventors herein have made the surprising discovery that the inherently crude measurement scale of memory-based recollections obtained from a first quantity of respondents can be enhanced using audiometric measurements obtained from a second quantity of respondents much smaller than the first quantity (i.e. on the order of one quarter to one third of the first quantity)—preserving the ability to provide granular measurements but avoiding the cost and complexity of engaging a full complement of audiometrically equipped respondents.

What follows, then, is a description of an illustrative method for combining media exposure data from two separate sources—namely, (a) memory-based recollections recorded by respondents in time-use diaries (TUDs) or as recall estimates (REs) obtained by contacting the respondents and (b) audiometric measurements representative of media exposure activity within time slots correlated to the same time intervals as those used in the TUDs or REs.

As will be explained in greater detail shortly, a time slot averaging technique is applied to reach, market share, and/or rating statistics derived from the audiometric data to develop respective index values. A set of index values, corresponding to media content to which respondents of a selected socio-demographic group were exposed within one or more specified time interval(s) accounted for in respondent TUDs or REs via a specified media channel, is used to adjust raw values of reach, market share, and/or market share derived from the recollection data. The result is a collection of hybrid audience measurements which provide a level of granularity sufficient for advertisers and other parties to assess the reach, market share, and/or gross rating points of specific advertising measurements and other media content falling within time slots too small to be captured using memory-based techniques alone.

The terminology used herein is for the purpose of describing particular embodiments only and is not intended to be limiting. As used in the specification and the appended claims, the singular forms “a,” “an” and “the” include plural referents unless the context clearly dictates otherwise.

As used herein, the term “audiometric measurement device” may be any portable measurement device adapted to be worn, carried and/or otherwise maintained in close enough proximity to respondents so as to monitor, at regular intervals and without user participation or intervention, the audio component of media content to which the respondent is being exposed. Examples of commercially available audiometric measurement devices which may be utilized to implement the techniques illustrated and described herein include the MEDIA WATCH commercially available from GfK Telecontrol AG and the PERSONAL PEOPLE METER commercially available from Arbitron Inc. Alternatively, the audiometric device may be implemented as a software application executed by a small handheld computer having a small visual display screen for user output and a miniaturized keyboard for user input. For example, in the case of a personal digital assistant (PDA) the input and output may be combined into a touch-screen interface. Other mobile computing devices include laptops and smartphones. Handheld computers may include information appliances; smartphones; personal digital assistants (PDA); cell or mobile phones; personal communicators; and ultra-mobile personal computers.

As used herein, the term “media outlet category” refers to a medium of communication whereby media content is distributed or otherwise delivered to a recipient. Examples of media outlet categories include television and radio (either of which being intended to encompass a plurality of channels that include over the air, satellite, cable and internet methods of delivery/transmission), as well as the internet itself, CDs and DVDs and other tangible storage media by which media content is distributed in an electronic file format.

As used herein, “media content” includes television and radio programming, advertising messages, video games, music and music videos, movies, and any other ubiquitous material having an audio component by which the material can be identified by conventional analytical techniques.

As mentioned above, methods of measuring exposure of an audience to media channels and media content, in accordance with the present invention, require the collection and analysis of data obtained from two different sources, the first of these being memory based measurements in the form of respondent recollections such, for example, as those recorded in Time-Use Diaries (“TUDs”) or as Recall Estimates (“REs”). As contemplated herein, a TUD constitutes a record kept by the subject of all television channels watched and/or all radio stations listened to over successive time intervals, preferably of equal duration. TUDs may record the aforementioned exposure activities over time intervals of 1-60 minutes, 1-24 hours, 1-52 weeks, or 1-100 years. The time intervals may be every 6-12 hours, or 12-24 hours. The time intervals may be 1-7 days. In accordance with an illustrative embodiment of the invention, entries by each respondent correspond to media exposure activity during quarter hour increments (time-intervals of fifteen minutes). A principal advantage of TUDs (as well as “REs”, for that matter) is that they may be used extensively as a means of measuring activity without incurring excessive cost or time commitment from respondents. To reduce the administrative burden associated with collecting the data, however, respondents may be requested or required to manually enter data into a database for subsequent analysis. However, such an approach increases the chances for transcription errors. As noted previously, even though recall is more proximal (at the end of a day rather than a week), TUDs are self-reported, and thus may be limited by errors of retrieval, telescoping, inference, recency and salience. Accordingly, the inventors herein propose to use a second data gathering modality.

In the illustrative example described throughout this specification, the hybrid audience measurement methodology of the present invention will be applied to the exposure of respondents to media content transmitted by or otherwise originating from radio stations within at least one specified geographic region or market. To this end, a group of respondents representative of various socio-demographic groups of interest and the population of the geographic region at large are provided with an audiometric measurement device which is small and unobtrusive enough that the respondents will carry or wear the device to any location where they may be exposed to media content. The number of respondents issued an audiometric measurement device is substantially smaller than the number from whom TUD and RE recollections are collected—on the order of one third to one fourth. According to an exemplary embodiment of the invention, each audiometric measurement device collects samples of ambient acoustic energy from which the source of the media content can be identified. In the commercially available GfK Telecontrol Media Watch device, these samples are stored as “audio fingerprints” and compared to a library of samples from all radio broadcast sources associated with the applicable region. Alternative arrangements utilize a watermark detection technique in which identifying information is derived from the audio signal. Regardless of the technique used, it will be readily appreciated by those skilled in the art that by using such audiometric measurement devices it is possible to develop, for each respondent, a minute-by-minute identification of every radio station to which they have listened and all media content to which they have been exposed during such listening.

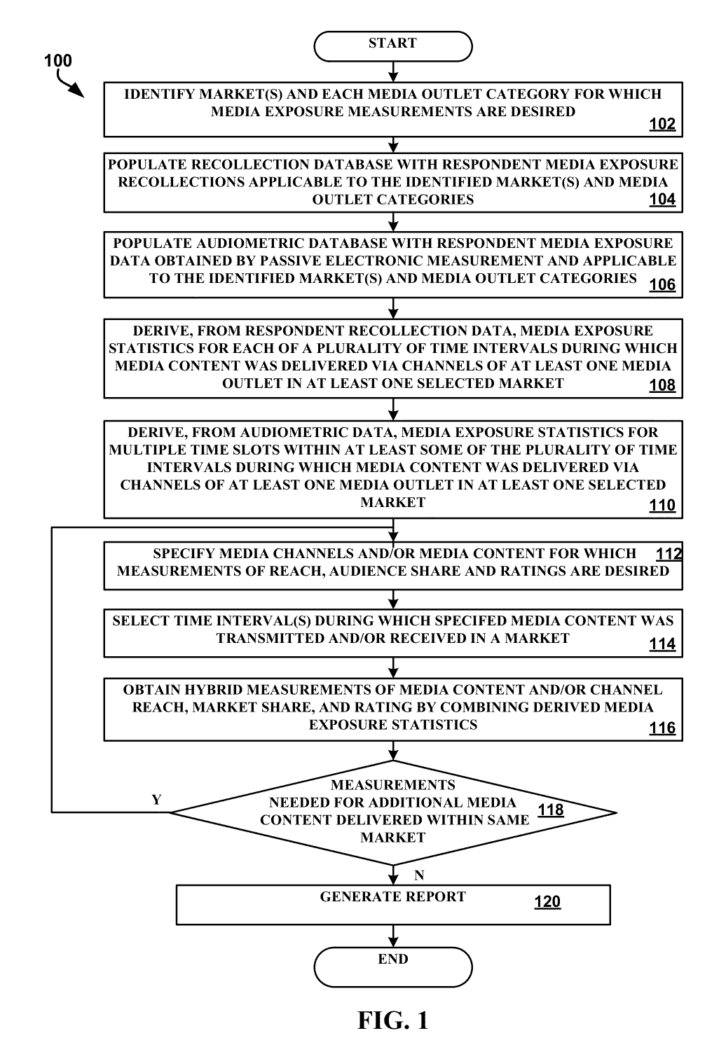

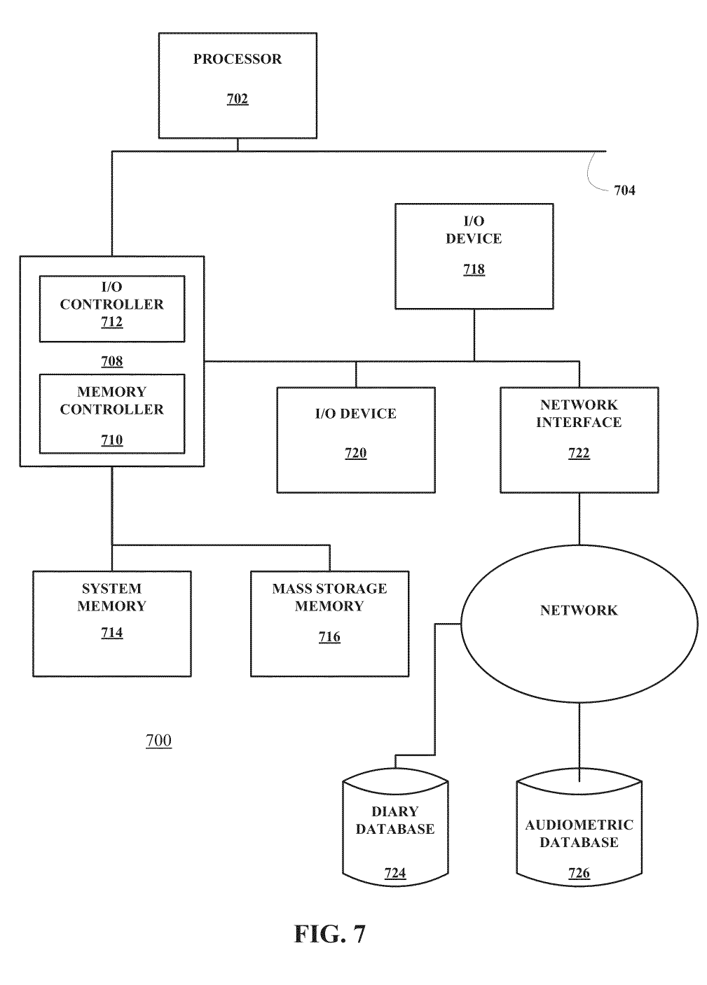

Flowcharts representative of exemplary machine readable instructions for implementing an illustrative hybrid audience measurement process in accordance with the present invention are shown in FIGS. 1-4. In this example, the machine readable instructions comprise a program for execution by one or more processors such as the processor 702 discussed below in connection with FIG. 7, a controller, and/or any other suitable processing device. The program(s) may be embodied in software stored on a tangible medium such, for example, as a flash memory, a CD-ROM, a floppy disk, a hard drive, a digital versatile disk (DVD), or a memory associated with the processor 702, but the entire program and/or parts thereof could alternatively be executed by a device other than the processor 702 and/or embodied in firmware or dedicated hardware (e.g., it may be implemented by an application specific integrated circuit (ASIC), a programmable logic device (PLD), a field programmable logic device (FPLD), discrete logic, etc.).

Also, some or all of the machine readable instructions represented by the flowcharts of FIGS. 1-4 may be implemented manually. Further, although the example program is described with reference to the flowcharts illustrated in FIGS. 1-4, many other methods of implementing the example machine readable instructions may alternatively be used. For example, the order of execution of the blocks may be changed, and/or some of the blocks described may be changed, substituted, eliminated, or combined.

In any event, and with particular reference to FIG. 1, it will be seen that the process 100 begins at block 102 where one or more markets and media outlet categories (e.g., radio) for which media exposure measurements are desired are identified or otherwise specified. The process proceeds to block 104, where a time-user database is populated with respondent media exposure recollection entries applicable to the identified market(s), media outlet category or categories, and channels thereof. In accordance with the illustrative embodiment, these entries reflect any radio listening activity occurring within successive intervals of duration n minutes. By way of example, the entries reflect what radio station each respondent recalls listening to during quarter hour (15 minute) increments throughout each day (e.g., 09:00 to 09:14, 09:15 to 09:29, etc).

At block 106, an audiometric measurement device is populated with respondent media exposure data obtained by passive, minute-by-minute electronic monitoring of ambient acoustic energy corresponding, for example, to any radio stations to which each respondent was listening throughout each day.

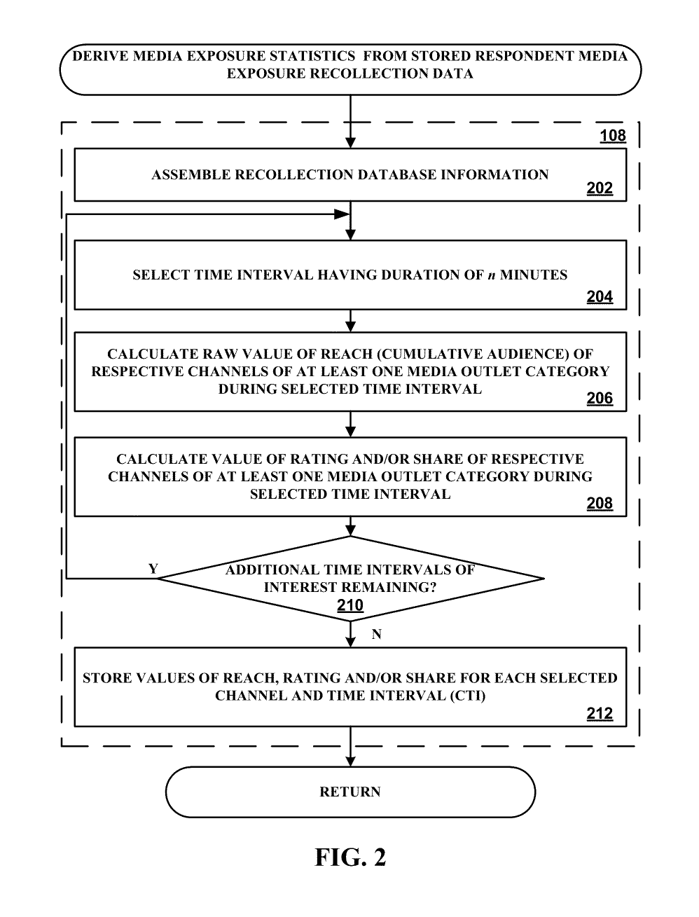

At block 108, media exposure statistics for each of a plurality of time intervals—during which media content (e.g., radio programming or advertisements) was delivered via one or more channels (e.g., a radio station) of at least one media outlet (e.g., broadcast radio) in a selected market—are derived from stored time-use diary data. As will be explained in greater detail shortly by reference to FIG. 2, these statistics may include reach, market share and ratings developed for each specified socio-demographic group, radio station, and time-use diary time interval.

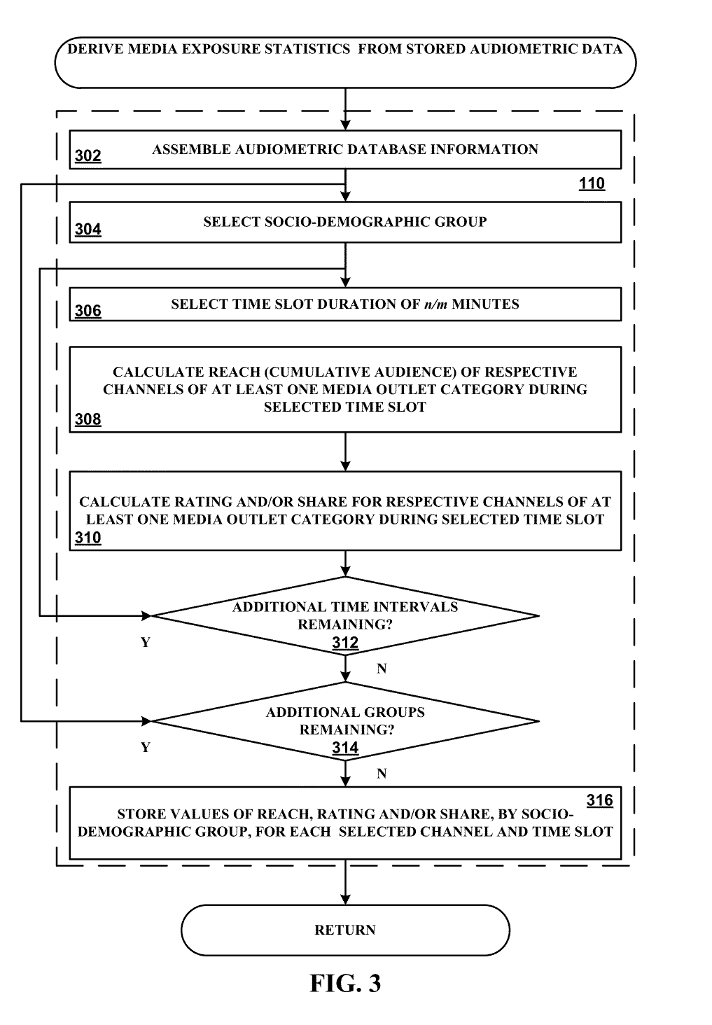

Likewise, at block 110, media exposure statistics for each time slot or a group of time slots corresponding to a time-use diary or recall estimate time interval—during which time slots respondents were exposed to media content (e.g., radio programming or advertisements) via channels (e.g., a radio station) of at least one media outlet (e.g., broadcast radio) in a selected market—are derived from stored audiometric measurement data. As will be explained in greater detail shortly by reference to FIG. 3, these statistics may include reach, market share and ratings developed for each specified socio-demographic group, radio station, and time slot.

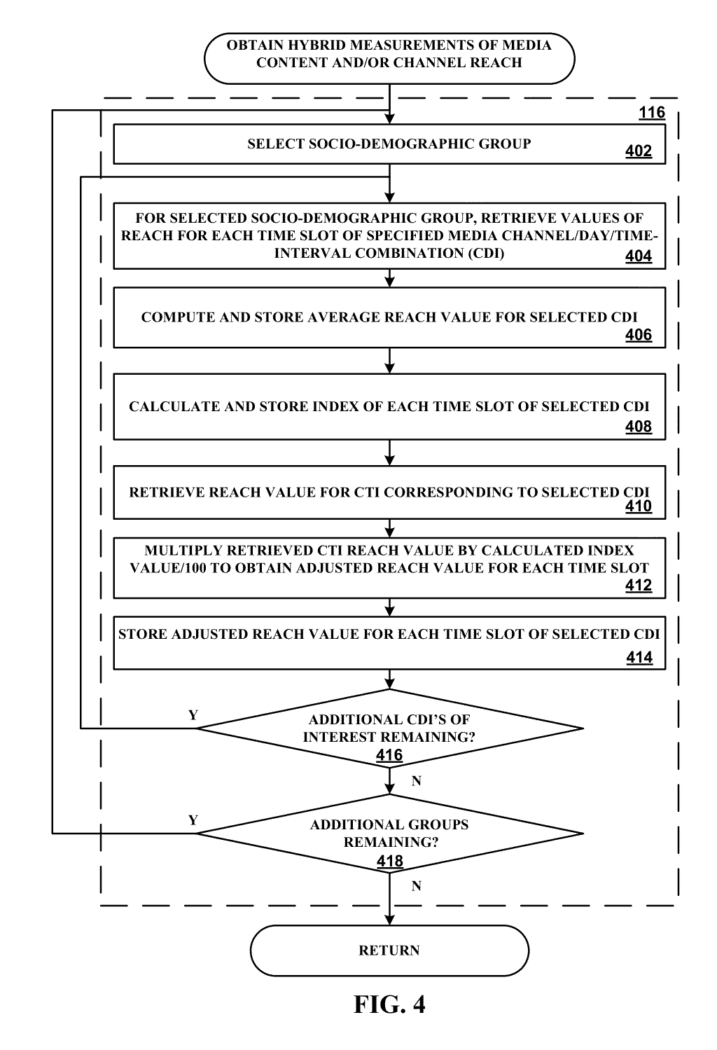

At block 112, media channels and/or media content, for which measurements of reach, audience share, and ratings are desired, are specified, and at block 114, time intervals during which specified media content—such, for example, as advertising messages of a product or service advertising campaign—were transmitted in a market, are specified so that specific, hybrid audience measurements for gauging the effectiveness of the campaign can be derived in accordance with the teachings of the present invention. To this end, at block 116, the measurements derived at blocks 110 and 112 are combined in accordance with a blending technique which will be described in detail shortly with reference to FIG. 4.

At decision block 118, a decision is made on whether there are any other media channels or media content for which hybrid measurements are required in accordance with the present invention. If the answer is yes, the process steps of blocks 112-116 are performed iteratively until hybrid measurements have been obtained for all desired media channels and/or content, at which point the process proceeds to block 120 where a report is generated to tabulate the hybrid measurements by demographic group, individual time slot, and media channel.

Turning now to FIG. 2, there is shown in greater detail the step 108 for deriving media exposure statistics from stored respondent media exposure recollection data. At step 202, recollection database information applicable to the market(s) and media outlet categories identified in step 102 (FIG. 1) is assembled. At block 204, an initial time interval having a duration of n minutes is selected. By way of illustrative example, this may be the first quarter hour segment of a four hour “morning traffic rush” period of interest to existing or prospective advertisers. At block 206, a raw value of reach (cumulative audience), market share and/or rating for the respective channels of at least one media outlet category (e.g., radio broadcasts) during an initial time interval (e.g., 09:00 to 09:14) is calculated for each socio-demographic group. If there are additional time intervals for which data are needed (e.g., 09:15 to 09:29 and so on), then at decision block 210 a decision is made to repeat the process steps represented by blocks 204 through 208 until weighted values of reach, market share and/or rating are obtained for all selected combinations of media channel (e.g. radio station) and time interval (CTIs). These values are calculated for each specified socio-demographic group and stored (block 212).

With reference now to FIG. 3, there is shown in greater detail the step 110 for deriving media exposure statistics from stored respondent media exposure recollection data. At step 302, audiometric measurement information applicable to the market(s) and media outlet categories identified in step 102 (FIG. 1) is assembled. At block 304, an initial socio-demographic group is specified and at block 306 an initial time slot of duration n/m minutes is selected, where n represents the duration in minutes of each time interval for which media exposure statistics were derived at step 108 (FIG. 1), and m represents a non-zero integer no greater than n. In an illustrative embodiment of the present invention, the time interval n is fifteen minutes and each time slot m is one minute in duration. At blocks 308 and 310, respectively, values of reach, rating, and market share are calculated—for the specified combination of socio-demographic group and time slot—for each media channel of a media outlet category.

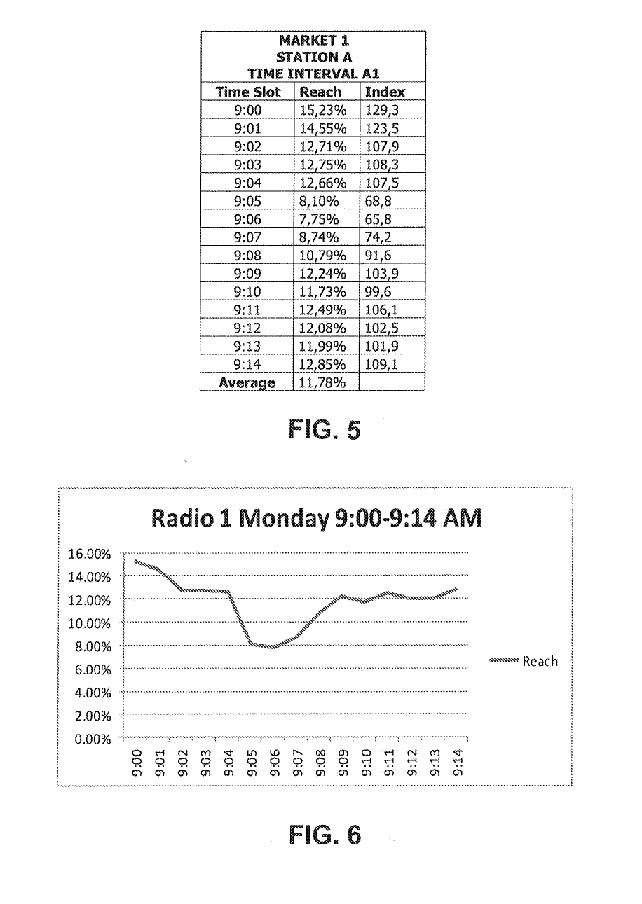

Turning briefly to FIG. 5, it will be seen that during the exemplary time interval Al (i.e. 08:59 to 09:00), audiometrically obtained media exposure data—representative of members of a specified socio-demographic group listening to specified Station A—yield a reach value for each one minute time slot. An average reach value for the time interval Al is obtained by adding the individual reach values for each time slot and dividing by the total number of time slots. In the example presented in FIG. 5, an average reach value of 11.78% is obtained for the specified time slot Al. For each discrete time slot within time interval Al, an index value is obtained by dividing the reach value for that time slot by the average reach value. Thus, for example, the 09:00 time slot within time interval Al yields an index value of 15.23%/11.78%=129.3, while the 9:06 time slot yields an index of 7.75%/11.75%=65.8. As will soon become apparent, it is the index value which allows the respective media exposure statistics to be combined to yield hybrid audience measurements in accordance with illustrative embodiments of the present invention. FIG. 6 graphically depicts the fluctuations in reach value over the course of time slot Al.

In any event and returning now to FIG. 3, it will be seen that at decision block 312, a determination is made as to whether there are any more time intervals for which reach, rating, and market share calculations are desired for the specified socio-demographic group. If so, the process returns to blocks 306 through 310 until no further calculations are needed for the initially specified group. If not, the process advances to block 314, wherein a determination is made as to whether reach, rating and/or market share statistics are needed for any other socio-demographic groups. If another group is specified, the process returns to block 304 and process steps 306 through 310 are repeated as before. The respective values of reach, rating, and/or share are stored, by socio-demographic group, for each selected channel and time slot, for subsequent analysis as will now be described by reference to FIG. 4

With reference now to FIG. 4, it will be seen that the process of obtaining hybrid measurements of media content and/or channel reach, rating, and/or market share, as identified by block 116 in FIG. 1, begins at block 402 wherein a socio-demographic group of interest is specified. For the initially specified socio-demographic group, raw values of reach for each time slot of a specified media channel/day/time interval combination (CDI) are retrieved (block 404). For each CDI, average reach and index values are calculated (blocks 406 and 408). A raw reach value for the CTI (block 212 of FIG. 2) corresponding to the initially selected CDI is retrieved (block 410). At block 412, the retrieved, raw CTI reach value is multiplied by the calculated index value (derived in block 408)/100 for each CDI time slot to thereby obtain an adjusted minute-by-minute reach value (i.e., by time slot).

By way of the illustrative example represented by FIGS. 5 and 6, and using the tabulated index values for the CDI combination of Station A and time interval Al, where the raw reach value derived from time-use survey data for the CTI combination of Station A and time interval Al is 10.42%, a hybrid reach value representative of the 09:02 time slot is obtained as the product: 10.42%×(107.9/100)=11.24%.

At block 414, the hybrid measure of reach is stored for the specified time slot and socio-demographic group. At blocks 416 and 418, decisions are made to perform the foregoing steps represented by blocks 402-414 for other CDIs and socio-demographic groups. When no further groups or CDIs remain, the process depicted in FIG. 1 resumes at block 118.

FIG. 7 is a block diagram of an example processor system 700 that may be used to execute the example machine readable instructions of FIGS. 1-4 to implement the example systems, apparatus, and/or methods described herein. As shown in FIG. 7, the processor system 700 includes a processor 702 that is coupled to an interconnection bus 704. The processor 702 includes a register set or register space (not shown), which is depicted in FIG. 7 as being entirely on-chip, but which could alternatively be located entirely or partially off-chip and directly coupled to the processor 702 via dedicated electrical connections and/or via the interconnection bus 704. The processor 702 may be any suitable processor, processing unit or microprocessor. Although not shown in FIG. 7, the system 700 may be a multi-processor system and, thus, may include one or more additional processors that are identical or similar to the processor 702 and that are communicatively coupled to the interconnection bus 704.

The processor 702 of FIG. 7 is coupled to a chipset 708, which includes a memory controller 710 and an input/output (I/O) controller 712. A chipset typically provides I/O and memory management functions as well as a plurality of general purpose and/or special purpose registers, timers, etc. that are accessible or used by one or more processors coupled to the chipset 708. The memory controller 710 performs functions that enable the processor 702 (or processors if there are multiple processors) to access a system memory 714 and a mass storage memory 716.

The system memory 714 may include any desired type of volatile and/or non-volatile memory such as, for example, static random access memory (SRAM), dynamic random access memory (DRAM), flash memory, read-only memory (ROM), etc. The mass storage memory 716 may include any desired type of mass storage device including hard disk drives, optical drives, tape storage devices, etc.

The I/O controller 712 performs functions that enable the processor 702 to communicate with peripheral input/output (I/O) devices 718 and 720 and a network interface 722 via an I/O bus. The I/O devices 718 and 720 may be any desired type of I/O device such as, for example, a keyboard, a video display or monitor, a mouse, etc. The network interface 722 may be, for example, an Ethernet device, an asynchronous transfer mode (ATM) device, an 802.11 device, a digital subscriber line (DSL) modem, a cable modem, a cellular modem, etc. that enables the processor system 700 to communicate with another processor system. TUD and Recall Estimate recollection data are stored in diary database 724, while audiometric data are stored within audiometric database 726, and are supplied for analysis via the network and network interface 722.

While the memory controller 710 and the I/O controller 712 are depicted as separate functional blocks within the chipset 708 in FIG. 7, the functions performed by these blocks may be integrated within a single semiconductor circuit or may be implemented using two or more separate integrated circuits.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed:

1. A method comprising:
deriving, in a first deriving step, respondent memory-based statistics representative of audience exposure to audio portions of target media content, said memory-based statistics being derived from a plurality of recollections obtained from a first quantity of respondents and corresponding to media exposure activity within time intervals of duration n minutes;
deriving, in a second deriving step, audiometrically-based statistics representative of audience exposure to audio portions of the target media content from a plurality of measurements obtained for each of a second quantity of respondents substantially smaller than the first quantity, the measurements being obtained by sampling ambient acoustic energy within consecutive time slots of duration n/m minutes, where m is an integer greater than zero and no greater than n;
identifying a plurality of time slots during which respondents from at least one of the first and second pluralities of respondents were exposed to the target media content; and
combining statistics obtained from the first and second deriving steps to ascertain a hybrid measurement of at least one of audience reach, market share and gross rating points for the target media content.

2. The method of claim 1, wherein the first deriving step includes calculating at least one of reach, market share, and gross rating points over a plurality of recollection intervals and media distributions by each of a plurality of media content outlets within a defined listening area.

3. The method of claim 2, wherein the duration of each recollection interval is fifteen minutes, and wherein the duration of each time slot is one minute.

4. The method of claim 2, wherein media content distributed includes commercial advertisements forming part of an advertising campaign.

5. The method of claim 2, wherein the second deriving step includes defining a plurality of broadcast station/day (SD) measurement intervals of n minute duration and calculating a value of reach for each n/m minute time slot within each SD measurement interval.

6. The method of claim 5, wherein each SD measurement interval and each recollection interval is fifteen minutes in duration and wherein each n/m time slot within an SD measurement interval and a diary interval is one minute in duration.

7. The method of claim 6, wherein the second deriving step further includes a step of calculating an average reach value for each SD measurement interval by summing each individual time slot reach value within an SD measurement interval and dividing by a total number of individual reach values.

8. The method of claim 7, wherein the second deriving step further includes a step of calculating an index value for each time slot within an SD measurement interval by dividing each individual time slot reach value within a respective SD measurement interval by a corresponding average reach or gross rating value for said respective SD measurement interval, whereby respective index percentage values are obtained by dividing each index value by 100.

9. The method of claim 8, further including a step of performing the second deriving step for each of a plurality of socio-demographic groups.

10. The method of claim 8, wherein said step of combining includes obtaining a hybrid radio audience measurement value, the hybrid radio audience measurement value being the product of a reach value calculated for a recollection interval containing a time slot during which an advertising message was delivered and an index percentage value associated with the time slot during which the advertising message was broadcast.

11. The method of claim 10, wherein said deriving steps and said combining steps are performed for each of a plurality of socio-demographic groups.

12. The method of claim 2, further including a step of obtaining the recollections, from which respondent memory-based statistics are derived, from respondent diary entries, wherein each recollection interval is a diary interval having a duration of n minutes and wherein n is between one and sixty minutes.

13. The method of claim 2, further including a step of obtaining the recollections, from which respondent memory-based statistics are derived, by contacting each respondent for a recall estimate of prior day media exposure activity, wherein each recollection interval is a recall estimate interval having a duration of n minutes and wherein n is between one and sixty minutes.

14. The method of claim 5, wherein the second deriving step further includes a step of calculating an average gross rating points value for each SD measurement interval by summing each individual time slot gross rating points value within an SD measurement interval and dividing by a total number of individual gross rating point values within the SD measurement interval.

15. The method of claim 14, wherein the second deriving step further includes a step of calculating an index value for each time slot within an SD measurement interval by dividing each individual time slot gross rating points value within a respective SD measurement interval by a corresponding average gross rating value for said respective SD measurement interval, whereby respective index percentage values are obtained by dividing each index value by 100.

16. The method of claim 15, further including a step of performing the second deriving step for each of a plurality of socio-demographic groups.

17. The method of claim 15, wherein said step of combining includes obtaining a hybrid radio audience measurement value, the hybrid radio audience measurement value being the product of a gross rating points value calculated for a recollection interval containing a time slot during which an advertising message was delivered and an index percentage value associated with the time slot during which the advertising message was broadcast.

18. The method of claim 17, wherein said deriving steps and said combining steps are performed for each of a plurality of socio-demographic groups.
